(19) United States
(12) Patent Application Publication
(10) Pub. No.: US 2021/0180542 A1
(43) Pub. Date: Jun. 17, 2021

(54) Water Injection Device of a Vehicle Internal Combustion Engine

(71) Applicant: Bayerische Motoren Werke Aktiengesellschaft, Muenchen (DE)

(72) Inventor: Andreas BRUHN, Puchheim (DE)

(21) Appl. No.: 17/256,548

(22) PCT Filed: Jun. 13, 2019
(86) PCT No.: PCT/EP2019/065476

§ 371 Date: Dec. 28, 2020

(30) Foreign Application Priority Data
Jun. 29, 2018 (DE) 10 2018 210 769.6

(51) Int. Cl. F02M 25/028; F02B 47/02

(52) U.S. Cl. CPC F02M 25/028; F02M 25/0227; F02B 47/02

(57) ABSTRACT

A water injection device is provided for a vehicle internal combustion engine having a storage tank for water and a conveying device which is connected to water and can convey water through a feed line into at least one injection valve which is assigned to the internal combustion engine and if required, in the case of a switched-off internal combustion engine, can convey it from the injection valve back in the direction of the storage tank. A device for separating air from the water which is conveyed back is provided in the feed line. The device for separating air is configured in the form of a container, in the upper interior region of which the at least one or more feed lines opens/open, whereas a forward feed line which is connected to the conveying device opens into the lower interior region of the container, and wherein, as viewed in the vertical direction, the upper interior region of the container is spaced apart further from a roadway, on which the vehicle is standing, than the lower interior region.

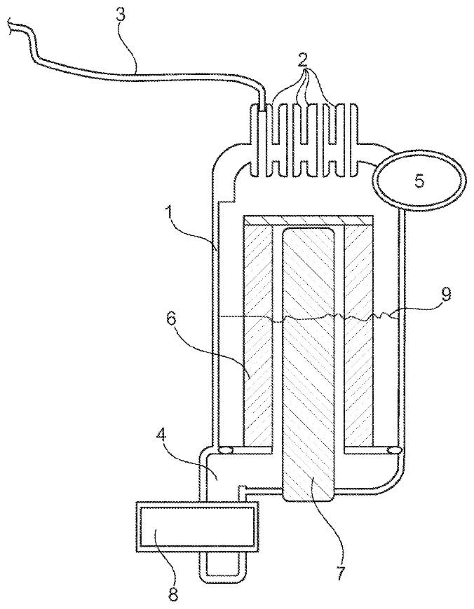

### BACKGROUND AND SUMMARY OF THE INVENTION

The invention relates to a water injection apparatus of a vehicle internal combustion engine with a storage tank for water, and with a conveying apparatus which is connected to the storage tank and can convey water through a feed line into at least one water injection valve which is assigned to the internal combustion engine, and can convey water back from this injection valve in the direction of the storage tank as required in the case of a stopped internal combustion engine. In respect of the prior art, reference is made by way of example to DE 10 2013 204 474 A1 and DE 10 2015 208 509 A1.

In the future, there will be increasing numbers of vehicle internal combustion engines, in the case of which water is added to the combustion of fuel at least at certain operating points. The water is preferably removed from a storage tank which is carried by the vehicle, and is conveyed by means of a conveying apparatus to at least one water injection valve which injects a defined water quantity (to be precise, exclusively water, and not a mixture of fuel and water, for instance), for example, into the air intake system of the internal combustion engine or into (in each case) one of the combustion chambers thereof. When the motor vehicle is switched off after operation for a time period of several hours in the cold season, water which is still situated in a feed line to the injection valve (merely an injection valve is spoken of in the further text for simplification reasons, even if it is the water injection valve) might freeze, as a result of which not only a supply of water to the combustion chambers of the internal combustion engine would not be possible for a relatively long time period after restarting the internal combustion engine, but rather, in particular, the feed line and the injection valve might also be damaged as a result of ice pressure. In order to remedy this, it is known for the water which is situated in the feed line and in the injection valve to be conveyed back into the storage tank after the motor vehicle is switched off, at least as required, that is to say at correspondingly low ambient temperatures.

The return preferably takes place with the aid of the conveying apparatus which is already present and generates a certain vacuum in the feed line for this purpose. For a successful return, the injection valve or possibly the plurality of injection valves (for example, a dedicated water injection valve can be provided for each internal combustion engine cylinder and/or each cylinder intake manifold) is or are opened at least slightly, with the result that air also passes into the feed line. The air can be contaminated, for example, with blow-by gases, and can therefore contain, for example, fuel constituent parts or oil constituent parts or particles, which contaminated vapors, however, should not pass into the storage tank, for example with regard to corrosion problems.

It is an object of the present invention to provide a measure to remedy this outlined problem.

This object is achieved by way of the features of the independent patent claim and, for a water injection apparatus, is characterized in that an apparatus for the separation of air from the returned water is provided in the feed line. Advantageous embodiments and developments are the subject matter of the subclaims.

In a separating apparatus according to the invention, gaseous constituent parts of a gas/liquid mixture (consisting namely of water and contaminated air) can be separated from liquid constituent parts, after which it is possible for merely the water which is returned into the apparatus for the separation of air to further be conducted back into the storage tank at least to a substantial extent, whereas the separated vapors which can contain the damaging constituent parts remain initially in the separating apparatus. They can be discharged from the latter in due course. In order to ensure here that the separated vapors do not pass into the storage tank, it can be provided that the return or extraction of water from the feed line is carried out in terms of time only until the feed line or, more precisely, its section which lies between the separating apparatus and the injection valve or valves at least substantially no longer contains water, whereas a certain quantity of water still remains at the same time in the separating apparatus in the region of an opening therein which is connected to the storage tank (via what is called a forward feed line here). This can be determined or monitored, for example, by way of measurement of the liquid level and/or by way of pressure measurement in the separating apparatus by means of a suitable sensor system, the sensor signals being evaluated in an electronic control unit which actuates the conveying apparatus (for the return of water) and possibly any valves in a suitable manner.

As far as the abovementioned discharge of the separated vapors or the contaminated air from the separating apparatus is concerned, this can take place, for example, after restarting of the motor vehicle and/or the internal combustion engine, by water being conveyed out of the storage tank into the separating apparatus, which water then presses the previously separated vapors out of the separating apparatus. For this purpose, a dedicated discharge opening can be provided, or the discharge of the vapors can take place by way of the feed line or lines and the open water injection valve or valves.

One possible and fundamentally simple embodiment of an apparatus according to the invention for the separation of air can be configured in the form of a vessel, in the upper (in the installed state) interior region of which the at least one feed line or plurality of feed lines open, whereas a forward feed line which is connected to the conveying apparatus opens in the lower interior region of the vessel, and, as viewed in the vertical direction, the upper interior region of the vessel being spaced further apart from a roadway, on which the vehicle is standing, than the lower interior region. In a vessel of this type which is, for example, hollow-cylindrical with a substantially vertical cylinder axis, the feed lines which lead to the injection valves can open on the upper end side, whereas what is known as the forward feed line which connects the vessel to the storage tank for water or, more precisely, to the conveying apparatus for water, opens in the region of the lower end side in the vessel. In a vessel of this type, in which, in the case of a sufficient size, the flow of gas/liquid mixture which is conveyed back from the injection valve to the storage tank is calmed, the gas will be separated from the liquid solely on account of the different specific weight.

In the context of one advantageous development, a filter element and/or a heating element for water can be provided in the apparatus for the separation of air. In the case of the conveying of water to the injection valves and/or in the case of the return of the water into the storage tank, any solid particles can be retained at the filter element. If, in particular, a certain water quantity still remains in the separating apparatus, for example in the vessel, when the return of the water has ended, as described further above, the water quantity, in the case of it freezing if the vehicle is switched off, can be thawed by means of a heating element which is, in particular, electric, if a heating element of this type is provided in the separating apparatus.

### BRIEF DESCRIPTION OF THE DRAWING

The single FIGURE shows is a sectional outline view of an exemplary embodiment of an apparatus for the separation of air from returned water in a water injection apparatus according to the invention.

### DETAILED DESCRIPTION OF THE DRAWING

The FIGURE shows merely an outline (in a section) of one exemplary embodiment of an apparatus for the separation of air from returned water in a water injection apparatus according to the invention. The FIGURE does not show a storage tank for water, a conveying apparatus for water between the storage tank and the illustrated air separating apparatus, and at least one injection valve for water, which injection valve opens into an intake section of an internal combustion engine (not shown) and is supplied by a feed line which emanates from the illustrated apparatus for the separation of air (from water which is conveyed back from the injection valve in the direction of the storage tank). The elements which are not shown here can also be gathered from the prior art which was cited at the outset.

The designation 1 denotes a vessel which acts as an apparatus 1 for the separation of air from water. The approximately circular-cylindrical vessel 1 is shown in the installed position in a motor vehicle, that is to say the cylinder axis of the vessel 1 runs in the vertical direction. Here, four connector stubs 2 for, in each case, one feed line 3 are provided on the upper end wall of the vessel 1, of which feed lines 3 only a single one is shown here. Each feed line 3 leads to a water injection valve (not shown) which opens into a constituent part of the intake section of an internal combustion engine which acts as a drive unit of the motor vehicle. What is known as a forward feed line 4 opens into the interior of the vessel 1 in its lower region, the other end of which forward feed line 4 is connected to a conveying apparatus (not shown) which, during operation of the motor vehicle, conveys or can convey water from a storage tank into the vessel 1 and through the latter to the injection valves.

As was described before the description of the figures, water is removed from the injection valves and the feed lines and is conveyed back into the storage tank at least partially in the case of the vehicle being switched off at least in the cold season, that is to say when the water which is situated, for example, in the feed lines might freeze, for which purpose, for example, the conveying apparatus can be operated with a reversed conveying direction. In order to prevent air and any particles which are contained in the air passing into the storage tank here, the apparatus 1 for the separation of air from the returned water is provided. Since the flow of water which is sucked back through the conveying apparatus is namely calmed in the volume of the vessel 1, the air collects in the vessel 1 in the upper volume region, whereas the water which has a higher specific weight passes downward to the forward feed line 4 or into the latter. The conveying apparatus is ideally operated during the returning of water into the storage tank in a manner which is suitably actuated such that a certain quantity of water which is shown here by way of a liquid level 9 always remains in the vessel 1. A suitable sensor system 5, formed by way of a pressure sensor and/or a filling level sensor which measures the height of the liquid level 9, is provided on or in the vessel 1, with the aid of the signals of which sensor system 5 an electronic control unit actuates the conveying direction in the abovementioned way.

A circular-cylindrical filter element 6 is arranged in the vessel 1 in a customary way, through which filter element 6 the water passes when flowing through the vessel 1. Furthermore, an electric heating element 7 is arranged here centrally within the filter element 6. A shut-off valve 8 is provided in the forward feed line 4, which shut-off valve 8 is closed after the return of water into the storage tank is ended.

1.-4. (canceled)

5. A water injection apparatus of a vehicle internal combustion engine with a storage tank for water, comprising:
a conveying apparatus which is connected to said storage tank and conveys water through a feed line into at least one injection valve which is assigned to the internal combustion engine, and conveys water back from the injection valve in a direction of the storage tank as required in case of a stopped internal combustion engine; and
a separating apparatus for separating air from the water conveyed back from the injection valve in the direction of the storage tank, wherein the separating apparatus is provided in the feed line.

6. The water injection apparatus according to claim 5, wherein
the separating apparatus is in the form of a vessel, in an upper interior region of which the feed line or a plurality of feed lines open,
a forward feed line, which is connected to the conveying apparatus, opens in a lower interior region of the vessel, and, as viewed in a vertical direction, the upper interior region of the vessel is spaced further apart from a roadway, on which a vehicle having the water injection apparatus is standing, than the lower interior region.

7. The water injection apparatus according to claim 6, further comprising:
a filter element and/or a heating element for water provided in the separating apparatus.

8. The water injection apparatus according to claim 5, further comprising:
a filter element and/or a heating element for water provided in the separating apparatus.

9. The water injection apparatus according to claim 5, further comprising:
a pressure sensor for determining pressure in the separating apparatus, wherein the signals of said pressure sensor are taken into consideration in a suitable manner in the case of actuating the conveying apparatus.
